(19) United States
(12) Patent Application Publication
(10) Pub. No.: US 2025/0061397 A1
(43) Pub. Date: Feb. 20, 2025

(54) AI-POWERED ENTERPRISE COPILOT SYSTEM AND METHOD

(71) Applicant: Asato Corporation, Saratoga, CA (US)

(72) Inventors: Vinay SAXENA, Fairview, TX (US); Anush MOHANDASS, Sunnyvale, CA (US); Srihari HOSAHALLI, Danville, CA (US)

(21) Appl. No.: 18/806,573

(22) Filed: Aug. 15, 2024

Related U.S. Application Data
(60) Provisional application No. 63/532,775, filed on Aug. 15, 2023.

(51) Int. Cl. G06Q 10/0631; G06Q 40/06

(52) U.S. Cl. CPC G06Q 10/06315; G06Q 40/06

(57) ABSTRACT

A non-transitory computer-readable medium having instructions stored to generate decision recommendations to optimize asset allocation in an enterprise, wherein the instructions, when executed by a processor, cause a processor to: obtain data information of an enterprise from more than one source; process the data information; generate a mapping of the valid users and valid asset classes to define a relationship and associated trend between an enterprise asset, an enterprise user, and enterprise costs; derive a usage information on the enterprise asset by the enterprise user based on the relationship and associated trend between the enterprise asset, enterprise user, and enterprise costs; provide the usage information on the enterprise asset by the enterprise user to an artificial intelligence (AI) system for data analysis and pattern recognition; analyze the recommendation based on whether the recommendations have materialized in the enterprise; and use the result to train the large language model module.

### CROSS REFERENCE TO RELATED APPLICATIONS

This application claims the benefit of domestic priority under 35 U.S.C. § 119(e) from Provisional U.S. Patent Application No. 63/532,775, filed Aug. 15, 2023, the disclosures of which are incorporated herein by reference in their entirety for all purposes.

### TECHNICAL FIELD

The embodiments described herein are generally directed to an artificial intelligence (AI) assistance system and method, and, more particularly, to an AI-powered copilot assistance system and method.

### BACKGROUND

Leaders in enterprises, especially Chief Information Officers, encounter numerous challenges in managing and allocating assets like computers, software licenses, and energy resources. A key difficulty for leaders is maintaining accurate and up-to-date inventory records of these assets. In rapidly changing technological environments, keeping track of asset lifecycles, usage patterns, and replacement schedules can be complex. As a result, mismanagement in this area can lead to over-purchasing or underutilization of assets, resulting in wasted capital and operational inefficiencies. Additionally, software licensing compliance is a critical concern, as improper management can lead to legal and financial repercussions, including penalties and fines.

Further, another major challenge is the optimization of assets and resource allocation to achieve cost savings while ensuring operational efficiency. Currently, the management system available can have challenges with balancing the budgetary constraints with the need for up-to-date technology and energy efficiency requires careful planning and forecasting. Leaders must analyze usage data and forecast future needs accurately to avoid both surplus and shortages. However, the existing art does not provide an automatized and efficient option. Further, the common artificial intelligence applications are not focused towards solving this problem.

To address these issues, an artificial intelligence enterprise copilot system and method have been developed to assist enterprise leaders and perform an analysis of the usage of enterprise assets by the users and generate a recommendation to drift asset allocation in an enterprise. The present disclosure is directed toward overcoming one or more of the problems discovered by the inventors.

### SUMMARY

In an embodiment, a non-transitory computer-readable medium having instructions stored to generate decision recommendations to optimize asset allocation in an enterprise, wherein the instructions, when executed by a processor, cause the processor to: obtain data information of an enterprise from more than one source, wherein the data information is associated with users, asset classes and costs, wherein the processor detects undiscovered existing users and assets; process the data information to identify valid users and asset classes, anomalies, and relationships between usage and costs; generate a mapping of the valid users and valid asset classes to define a relationship and associated trend between an enterprise asset, an enterprise user, and enterprise costs; derive a usage information on the enterprise asset by the enterprise user based on the relationship and associated trend between the enterprise asset, enterprise user, and enterprise costs; provide the usage information on the enterprise asset by the enterprise user to an artificial intelligence (AI) system for data analysis and pattern recognition, wherein the AI system includes one or more large language model module configured to perform an analysis of the usage information on the enterprise asset by the enterprise user to optimize asset allocation in an enterprise, wherein the large language model module utilizes a natural language processing interface; analyze the recommendation based on whether the recommendations have materialized in the enterprise, wherein the enterprise performs an action based on whether the recommendation has materialized; and use the result to train the large language model module.

In an embodiment, a method comprising using at least one hardware processor to: obtaining data information of an enterprise from more than one source; wherein the data information is associated with users, asset classes and costs, wherein the processor detects undiscovered existing users and assets; processing the data information to identify valid users and asset classes, anomalies, and relationships between usage and costs; generating a mapping of the valid users and valid asset classes to define a relationship and associated trend between an enterprise asset, an enterprise user, and enterprise costs; deriving a usage information on the enterprise asset by the enterprise user based on the relationship and associated trend between the enterprise asset, enterprise user, and enterprise costs; providing the usage information on the enterprise asset by the enterprise user to an artificial intelligence (AI) system for data analysis and pattern recognition, wherein the AI system includes one or more large language model module configured to perform an analysis of the usage information on the enterprise asset by the enterprise user to optimize asset allocation in an enterprise, wherein the large language model module utilizes a natural language processing interface; analyzing the recommendation based on whether the recommendations have materialized in the enterprise, wherein the enterprise performs an action based on whether the recommendation has materialized; and using the result to train the large language model module.

In an embodiment, a system to generate decision recommendations to optimize asset allocation in an enterprise, the system comprises: at least one hardware processor; and software that is configured to, when executed by the at least one hardware processor, obtaining data information of an enterprise from more than one source, wherein the data information is associated with users, asset classes and costs, wherein the processor detects undiscovered existing users and assets; processing the data information to identify valid users and asset classes, anomalies, and relationships between usage and costs, generating a mapping of the valid users and valid asset classes to define a relationship and associated trend between an enterprise asset, an enterprise user, and enterprise costs; deriving a usage information on the enterprise asset by the enterprise user based on the relationship and associated trend between the enterprise asset, enterprise user, and enterprise costs, providing the usage information on the enterprise asset by the enterprise user to an artificial intelligence (AI) system for data analysis and pattern recognition, wherein the AI system includes one or more large language model module configured to perform an analysis of the usage information on the enterprise asset by the enterprise user to optimize asset allocation in an enterprise, wherein the large language model module utilizes a natural language processing interface; analyzing the recommendation based on whether the recommendations have materialized in the enterprise, wherein the enterprise performs an action based on whether the recommendation has materialized, and using the result to train the large language model module.

It should be understood that any of the features in the methods and systems above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure in which one or more of the disclosed processes may be implemented, according to an embodiment;

FIG. 2 illustrates a processing system that may be used to implement processes described herein, according to an embodiment;

FIG. 3 illustrates a conceptual architecture of a machine learning model module in an AI-powered enterprise copilot system, according to an embodiment;

FIG. 4 illustrates an example of a large language model conceptual architecture application in an AI-powered enterprise copilot system, according to an embodiment;

FIG. 5 illustrates an example of the foundational building blocks in a platform using an AI-powered enterprise copilot system, according to an embodiment;

FIG. 6 illustrates an example of an asset data information stages for an AI-powered enterprise copilot system, according to an embodiment;

FIG. 7 illustrates an example of an asset data information processing logical view in an AI-powered enterprise copilot system, according to an embodiment;

FIG. 8 illustrates an example of an asset usage storage in an AI-powered enterprise copilot system, according to an embodiment;

FIG. 9 illustrates an example of an asset usage storage processing logical view in an AI-powered enterprise copilot system, according to an embodiment;

FIG. 10 illustrates an example of an asset plane processing logical view in an AI-powered enterprise copilot system, according to an embodiment;

FIG. 11 illustrates an example of a knowledge plane data insight generation in an AI-powered enterprise copilot system, according to an embodiment;

FIG. 12 illustrates an example of an insight model in an AI-powered enterprise copilot system, according to an embodiment;

FIG. 13 illustrates an example of a generated insight model in an AI-powered enterprise copilot system, according to an embodiment;

FIG. 14 illustrates an example of a large language model training using retrieval-augmented generation in an AI-powered enterprise copilot system, according to an embodiment;

FIG. 15 illustrates a knowledge plane future state, according to an embodiment;

FIG. 16 illustrates an example of an AI-powered enterprise copilot system, according to an embodiment;

FIG. 17 illustrates an example of an MFE-based user interference design architecture in an AI-powered enterprise copilot system, according to an embodiment;

FIG. 18 illustrates a user interference and/or user plane in an AI-powered enterprise copilot system, according to an embodiment;

FIG. 19 a high-level architecture of the AI utilized in an AI-powered enterprise copilot system, according to an embodiment;

FIGS. 20A-C illustrate dataset variations in an AI-powered enterprise copilot system, according to an embodiment; and

FIG. 21 illustrates the pros and cons of an AI-powered enterprise copilot system based on different dataset variations.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

In general, this application refers to a machine learning model (LLM) module in an AI-powered enterprise copilot system and method. Initially, the system comprises a canonical data model for enterprise with flexible data ingestion and processing. The system can utilize a straightforward, efficient data model to represent enterprise assets. The disclosed machine learning model can be crafted with adaptability at its core and enables the system to ingest data from diverse sources and systems. Further, the system can map the data to effectively construct an enterprise asset graph. This adaptability significantly reduces previous systems' complexities, allowing users to manage data that best aligns with their unique requirements and instilling a sense of control and confidence.

Next, the system can conduct an enterprise asset discovery. Through an agentless process that brings data from various sources and systems and discovers assets. The system's asset discovery relies on external data (ITSM, ITOM, Financial Systems, Network Traffic Management Systems, CASB, and others) to identify assets within the enterprise. These assets then inherit a rich metadata schema to allow for richer data services analytics using an array of machine learning models to analyze data.

Following the ingestion and mapping of data, the system employs a robust entity resolution process to resolve SaaS & Enterprise Software Services to well-known entities. Once that is done, the system can represent the relationship between the nodes and/or edges to allow richer insights generated from the platform. This process allows a “360-degree” view of the existing assets within the enterprise. The system provides a comprehensive 360-degree view, from user demographics to cost analysis, security and compliance issues, and rich usage data history. This wealth of information empowers them to make informed, data-driven decisions, fostering a sense of empowerment and confidence.

After the information is organized, the system can process the information through an asset drift and optimization models to allow enterprise customers to see how assets drift (location, operational statuses, and other) and how the system can help enterprise customers look at usage data from their employees to optimized licensing based on actual usage. In an embodiment, the system comprises a conversational agent interface. The conversational agent interface can use a modern LLM and Natural Language Processing (NLP) capabilities to dynamically create charts and/or graphs based on user requests rather than prebuild them in a catalog, allowing for a much richer experience.

Finally, the system allows for feedback to analyze the actions and/or recommendations from the system's platform and based on incoming data, whether the actions and/or recommendations have materialized in the enterprise. This allows for constant supervision system changes, analyze the changes, and compare them to the system's actions and/or recommendations to evaluate organizational effectiveness for asset management. This can be accomplished through the system's graphs, which allows the system to infer based on data effectiveness of actions. This results in a better IT experience for enterprise users and an optimization engine for enterprise leaders to rely on for decision tracking. The details of the LLM module 420 in an AI-powered enterprise copilot system and method are further explained in the figure descriptions below.

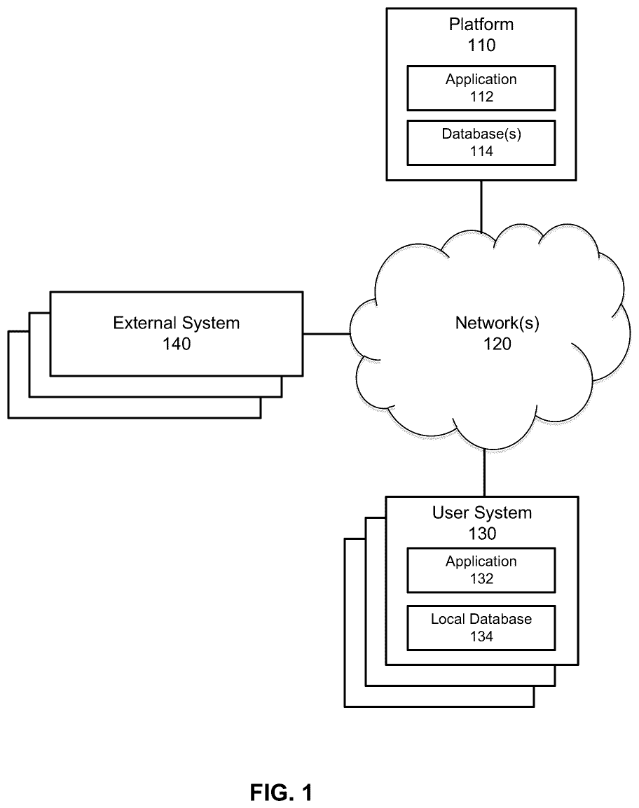

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes (e.g., methods or functions, implemented as software modules) described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 1010 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 1020, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™ Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 1012), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes (e.g., methods and functionality), storage, and/or the like, described herein. For example, in such an embodiment, a client application 132, executing on one or more user system(s) 130, may interact with a server application 112 executing on platform 110 to execute one or more or a portion of one or more of the various process(es) described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes (e.g., methods or functions) described herein.

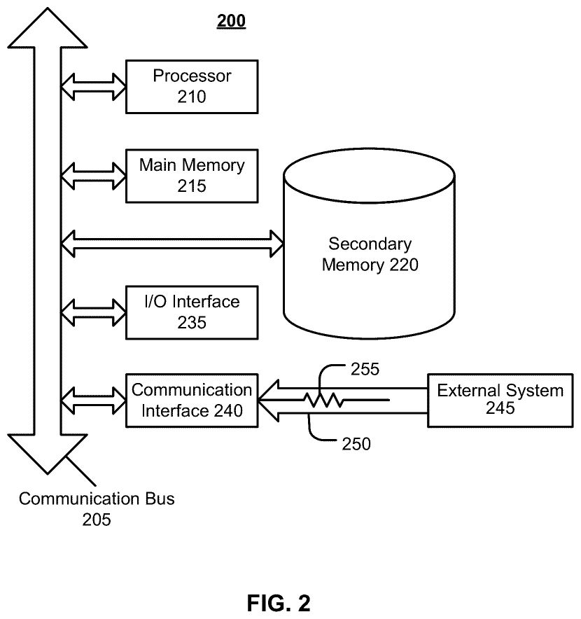

FIG. 2 illustrates a processing system that may be used to implement processes described herein. System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/5-100, and/or the like.

System 200 may comprise main memory 215. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

System 200 may comprise an input/output (I/O) interface 235. I/O interface 235 provides an interface between one or more components of system 200 and one or more input and/or output devices.

System 200 may comprise a communication interface 240. Communication interface 240 allows software to be transferred between system 200 and external devices, networks, or other information sources. For example, computer-executable code and/or data may be transferred to system 200, over one or more networks, from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network, or any variety of other communication links. Communication channel 250 carries signals 555 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed by processor(s) 210, enable system 200 to perform the various functions of the disclosed embodiments as described elsewhere herein.

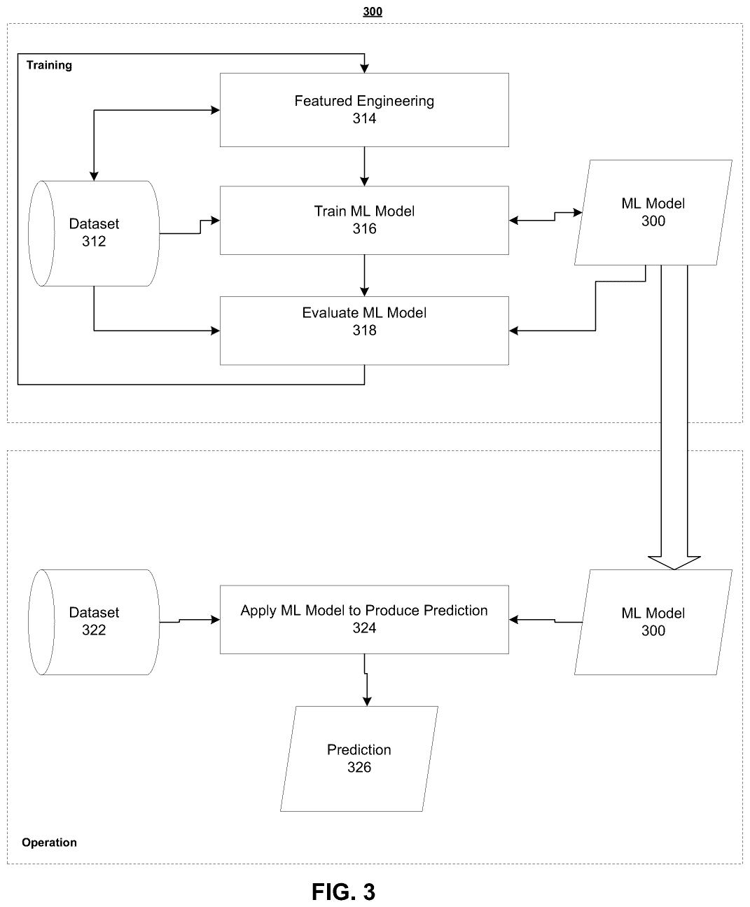

FIG. 3 illustrates a conceptual architecture of a machine learning model module in an AI-powered enterprise copilot system and method, according to an embodiment. In an embodiment, the application may utilize one or more machine-learning models or other artificial intelligence (AI) to facilitate one or more aspects of project management. FIG. 3 illustrates a high-level diagram of machine learning, according to an embodiment. In general, each machine-learning model 300 is trained to make predictions and/or recommendations in a training stage 310 and operated to make predictions in an operation stage 320. It should be understood that each machine-learning model 300 used by the application may undergo its own training stage 310 and operation stage 320, and that two or more machine-learning models 300 may operate independently from each other to perform different predictive tasks or may operate in combination with each other to perform a single predictive task.

In training stage 310, a machine-learning (ML) model 300 is trained using a dataset 312. Machine-learning model 300 may be trained using supervised or unsupervised learning. In supervised learning, dataset 312 may comprise vectors of features, with each feature vector labeled or annotated with the desired output and comprising a plurality of features that may be relevant to the determination of that output. In a case in which machine-learning model 300 is intended to perform image recognition or classification, dataset 312 may instead comprise images that have been labeled or annotated with the desired recognition or classification output. In either case, dataset 312 may be cleaned and augmented in any known manner.

In subprocess 314, feature engineering may be used to identify the features to be used in the feature vectors in dataset 312. The feature engineering may utilize any known manner of identifying relevant features that may correlate to an output. Features that are determined to be irrelevant may be removed from the feature vectors of dataset 312. In an alternative embodiment or embodiments which do not use feature vectors (e.g., image recognition or classification), subprocess 314 may be omitted.

In subprocess 316, machine-learning model 300 is trained using dataset 312. Specifically, machine-learning model 300 is applied to dataset 312 (e.g., which may be divided into training and validation datasets) and updates its internal structure to minimize the error between the desired output, represented by the labels in dataset 312, and its actual output. Machine-learning model 300 may comprise any type of machine-learning algorithm, including, without limitation, an artificial neural network (e.g., a convolutional neural network, a deep neural network, etc.), a linear regression, a logistic regression, a decision tree, a random forest algorithm, a support vector machine (SVM), a naïve Bayesian classifier, a k-Nearest Neighbors (kNN) algorithm, a K-Means algorithm, gradient boosting algorithms (e.g., XGBoost, LightGBM, CatBoost), and the like. It should be understood that the particular machine-learning algorithm that is used will depend on the problem being solved, and that different machine-learning algorithms may be used by platform 110 for different tasks.

In subprocess 318, machine-learning model 300 may be evaluated to determine its accuracy in performing the predictive task for which it was designed. If the accuracy is not sufficient, the training stage 310 may continue. For example, a different set of features may be used for training, a different dataset 312 may be used for training, a different machine-learning algorithm may be used, and/or the like, until the evaluation in subprocess 318 demonstrates that machine-learning model 300 is suitably accurate. It should be understood that the necessary accuracy may depend on the predictive task for which machine-learning model 300 was designed. For example, a machine-learning model 300 used for a predictive task that may affect a client interaction may require more accuracy than a machine-learning model 300 used for a predictive task that only affects internal interactions between team members.

Once machine-learning model 300 has been trained to a sufficient accuracy, machine-learning model 300 may be moved to operation stage 320 to perform its predictive task on data 322 in a production environment of platform 110. Data 322 may comprise feature vectors derived from any of the data discussed herein and/or image data derived from any of the media discussed herein (e.g., photographs, video, etc.). In subprocess 324, machine-learning model 300 is applied to data 322 to produce a prediction 326. Prediction 326 may comprise a classification (e.g., a single most likely classification, a probability vector comprising confidences for each of a plurality of possible classifications, etc.), a recommendation (e.g., recommended next action), and/or the like.

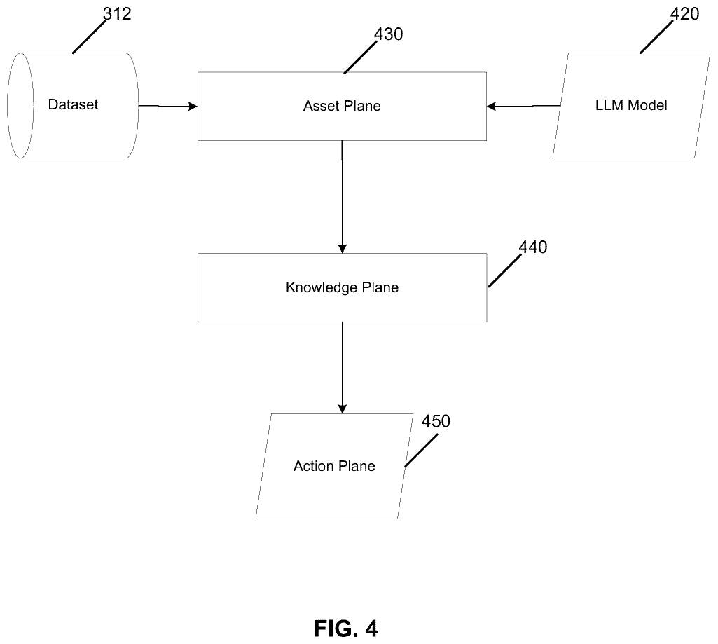

FIG. 4 illustrates an example of a large language model (LLM) conceptual architecture application 400 in an AI-powered enterprise copilot system, according to an embodiment. In an embodiment, large language model conceptual architecture application 400 comprises a dataset 312 and an LLM module 420 that feeds information into an asset plane 430. After, the information processed in asset plane 430 is transferred into knowledge plane 440 to be analyzed and converted into insights that enable decisions in action plane 450 to orchestrate a decision-action-outcome.

In LLM conceptual architecture application 400, dataset 312 can come from a diverse array of sources, metadata form SaaS or Cloud data sources, allowing the AI-powered enterprise copilot system to generate responses based on a broad spectrum of information including users, asset class, costs, customer input, and usage. Dataset 312 can be processed during training to capture various aspects of language and knowledge, enabling the AI-powered enterprise copilot system to understand context, nuances, and factual content. Further, dataset 312 can include information related to users to discover all valid users in an enterprise using multiple sources. As well, dataset 312 can discover existing asset classes (e.g. hardware or applications) and the associated metadata. Additionally, dataset 312 can comprise the usage and utilization of various asset classes by the users.

Further, LLM conceptual architecture application 400 comprises an LLM module 420 as shown in FIG. 3. LLM module 420 can comprise as a Natural Language Processing (NLP) interface by interpreting and generating human-like text based on vast amounts of data from dataset 312. LLM module 420 can analyze language input to provide insights and relevant information, enabling users to extract meaningful patterns or trends from dataset 312. LLM module 420 may also support decision-making by synthesizing information from dataset 312, offering recommendations, and automating responses, thereby orchestrating actions or decisions to optimize asset usage and allocation. Essentially, LLM module 420 acts as an advanced tool for understanding and interacting with textual data received from a dashboard or user operation through user interface, streamlining analysis and decision processes for asset usage and allocation in the AI-powered enterprise copilot system.

As previously described, dataset 312 and LLM module 420 feed information into asset plane 430. Asset plane 430 encompasses the underlying structure and dynamics of how the AI-powered enterprise copilot system interacts with and manipulates the information to deliver meaningful outputs and support decision-making. Asset plane 430 discovers, links, enriches, and orchestrates across sources the information received by dataset 312 and LLM module 420.

After, the information processed in asset plane 430 is transferred into knowledge plane 440 to be analyzed and converted into insights. Knowledge plane 440 refers to the conceptual layer that represents the model's internal understanding and organization of knowledge received from asset plane 430. This includes the vast array of information associated with the assets, users, costs, and usage that the model has been trained on, encompassing patterns, relationships, and domain-specific content. Here, the AI-powered enterprise copilot system can make inferences, and provide insights, reflecting LLM module 420 depth and breadth of learned information. More specifically, the AI-powered enterprise copilot system can perform dataset 312 analysis and pattern recognition via one or more LLM modules 420 configured to perform an analysis of the usage information on the enterprise asset by an enterprise user to optimize asset allocation in an enterprise.

Finally, the insights from knowledge plane 440 enable decisions in action plane 450 to orchestrate a decision-action-outcome. Action plane 450 refers to the layer that deals with how the AI-powered enterprise copilot system can generate outputs and translate into concrete actions or decisions. Action plane 450 can include the implementation of practical functions such as automating workflows, providing recommendations, or executing commands. For example, recommending an enterprise leader to drift assets from one facility to another. In a more specific context, action plane 450 can recommend a leader to remove hardware from facility A, and allocate the hardware to facility B. If a leader (CIO) follows an action based on the recommendation, the AI-powered enterprise copilot system materializes the recommendation and uses the result to train the large language model module.

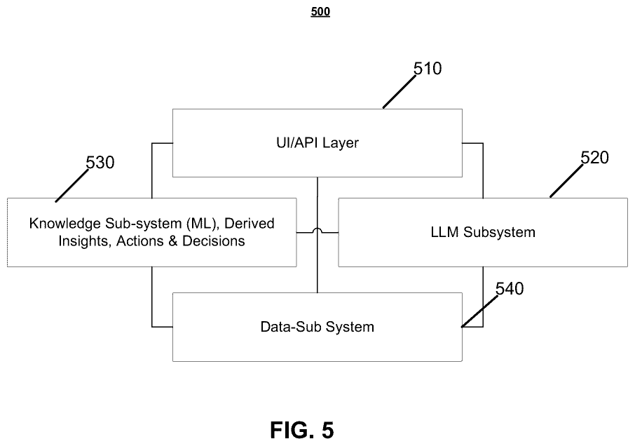

FIG. 5 illustrates an example of the foundational building blocks 500 in a platform using an AI-powered enterprise copilot system, according to an embodiment. Foundational building blocks 500 can comprise a user interface (UI) and/or an application programming interface (API) layer 510, an LLM subsystem 520, a knowledge subsystem 530, and a data subsite, 540. Foundational building blocks 500 can interact between each other, and at the same time interchange information.

UI/API layer 510 acts as an intermediary between a user interface (UI) and backend systems or services of the AI-powered enterprise copilot system. The UI layer is responsible for presenting data and facilitating user interactions, while the API (Application Programming Interface) layer handles the communication between the frontend and backend components of the AI-powered enterprise copilot system. The UI layer can capture user inputs and displays information, while the API layer processes these inputs, retrieves or updates data from the backend, and sends responses back to the UI layer.

Foundational building blocks 500 can include an LLM subsystem, as described in FIGS. 3-4. LLM subsystem 520 in a platform that interacts with the AI-powered enterprise copilot system refers to a specialized component designed to handle natural language processing tasks using advanced machine learning models. LLM subsystem 520 can leverages extensive training data and sophisticated algorithms to understand, generate, and manipulate human language, enabling features such as conversational interfaces, content generation, and language translation.

Further, foundational building blocks 500 can include knowledge subsystem 530. Knowledge subsystem 530 can be based on a machine learning model and/or AI. Knowledge subsystem 530 can perform data analysis, predictive modeling, and pattern recognition recommendations for asset allocation using machine learning algorithms. Additionally, knowledge subsystem 530 can integrate datasets 312, train models, and generate insight, actions, and decisions. Knowledge subsystem 530 can include elements such as data preprocessing, model training, and evaluation components, as well as inference engines that apply the trained models to new data.

Finally, foundational building blocks 500 in a platform using an AI-powered enterprise copilot system can include a data subsystem 540. Data subsystem 540 in a platform can manage, store, and process data across the AI-powered enterprise copilot system. Data subsystem 540 can include databases, data warehouses, and data processing engines that handle the ingestion, organization, and retrieval of information.

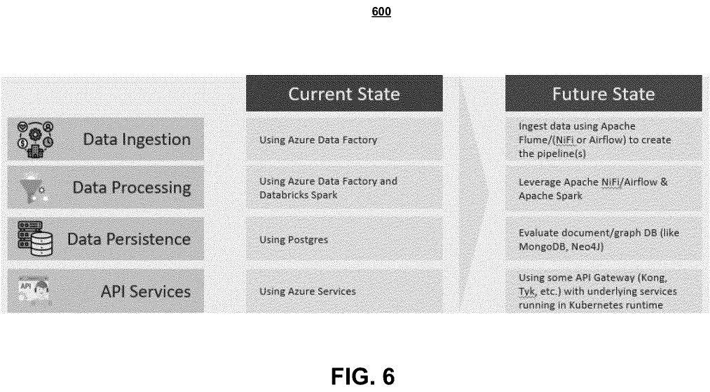

FIG. 6 illustrates an example of asset data information stages 600 for an AI-powered enterprise copilot system, according to an embodiment. Asset data information stages 600 can comprise data ingestion, data processing, data persistence, and API services. As previously described, assets can include, but are not limited to, users, SaaS applications, infrastructure resources (e.g. cloud instances), and end devices. The AI-powered enterprise copilot system can collect this information from many places, and the information about these is primarily static. The information in the AI-powered enterprise copilot system is used mainly in the linking phase to construct a knowledge graph.

Further, the information is mostly batch-oriented, not frequently changing, data collected using plugins that read from enterprise sources. It should be understood that while complexity in the data is not completely developed today, as asset types increase (like cloud resources, infra, devices), metadata will increase, and managing that in JSON structure will serve a more complete purpose for data collection.

As part of asset data information stages 600, data ingestion can comprise collecting, importing, and processing data for use in the AI-powered enterprise copilot system. Data ingestion involves gathering raw data from various sources, such as enterprise databases or a cloud, and preparing it for analysis. Data ingestion can include tasks like cleaning, transforming, and organizing the data to ensure it is in a suitable format for the AI-powered enterprise copilot system.

Further, asset data information stages 600 comprises data processing. In the AI-powered enterprise copilot system, data processing involves transforming and organizing the received data into a format suitable for analysis and model training. This process includes cleaning the data to remove errors or inconsistencies, normalizing or scaling data to ensure uniformity, and feature extraction to identify and select relevant variables.

The data persistence stage in asset data information stages 600 refers to the method of storing and maintaining data over time, ensuring that it remains available and retrievable for future use. Data persistence can help the AI-powered enterprise copilot system manage large volumes of enterprise data and maintain the continuity of information across different stages of the AI lifecycle. Persistent storage allows for historical data analysis, model retraining, and trend tracking, facilitating long-term insights and improvements. Persistent storage for the AI-powered enterprise copilot system can be managed through databases (DB) for structured data and block files for efficient handling of large volumes of unstructured data.

Another stage of asset data information stages 600 includes API services. API services provide a standardized interface for different software applications to interact with the AI-powered enterprise copilot system and access the AI-powered enterprise copilot system functionalities. This allows developers to integrate AI capabilities, such as natural language processing or image recognition, into their own applications without needing to understand the underlying complexity.

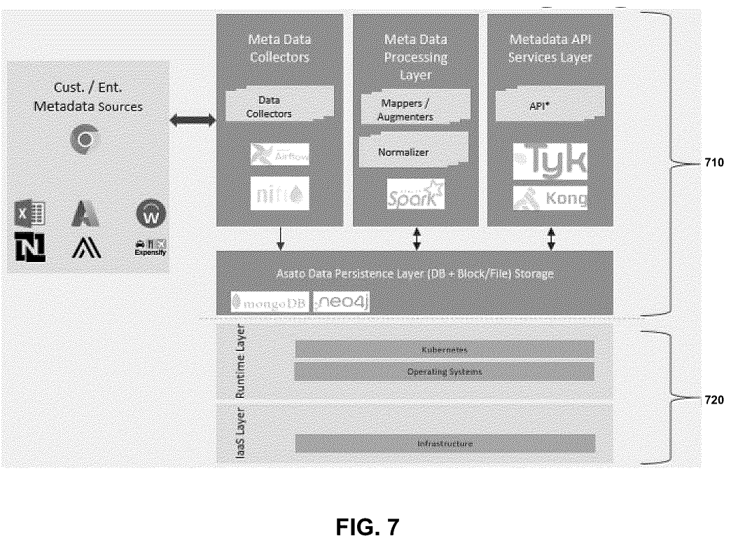

FIG. 7 illustrates an example of an asset data information processing logical view in an AI-powered enterprise copilot system, according to an embodiment. In this example, the information is retrieved from a customer or enterprise metadata source. As described in FIG. 6, process 710 can include one or more of asset data information stages 600 in the AI-powered enterprise copilot system.

Further, the data received in process 710 can further undergo through process 720. Process 720 comprises a runtime layer and an IaaS layer. A runtime layer and an Infrastructure as a Service (IaaS) layer serve distinct but complementary roles in the AI-powered enterprise copilot system. The runtime layer provides the environment necessary for executing applications of the operating systems, managing tasks like memory allocation and system interactions. On the other hand, the IaaS layer offers foundational computing resources over the cloud, including storage, and networking.

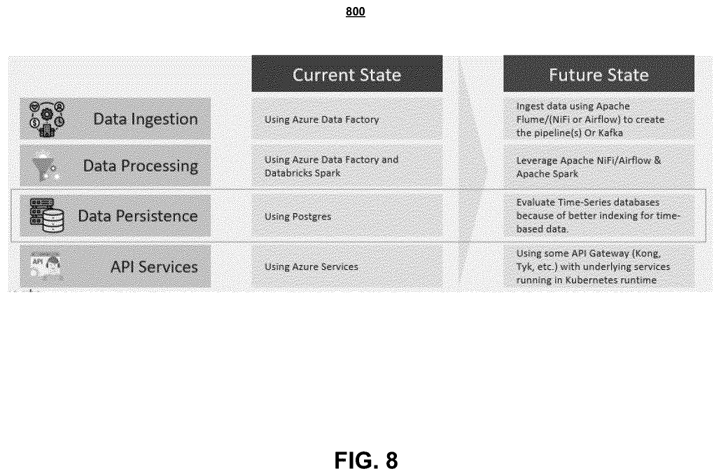

FIG. 8 illustrates an example of an asset usage storage in an AI-powered enterprise copilot system, according to an embodiment. In this example, the figure focuses on illustrating the data persistence. As explained in FIG. 6, the data persistence stage in asset data information stages 600 refers to the method of storing and maintaining data over time, ensuring that it remains available and retrievable for future use. Data persistence can help the AI-powered enterprise copilot system manage large volumes of enterprise data and maintain the continuity of information across different stages of the AI lifecycle. Persistent storage allows for historical data analysis, model retraining, and trend tracking, facilitating long-term insights and improvements. Persistent storage for the AI-powered enterprise copilot system can be managed through databases (DB) for structured data and block files for efficient handling of large volumes of unstructured data.

Further, FIG. 8 illustrates future potential uses such as evaluating time-series databases because of better indexing for time-based data.

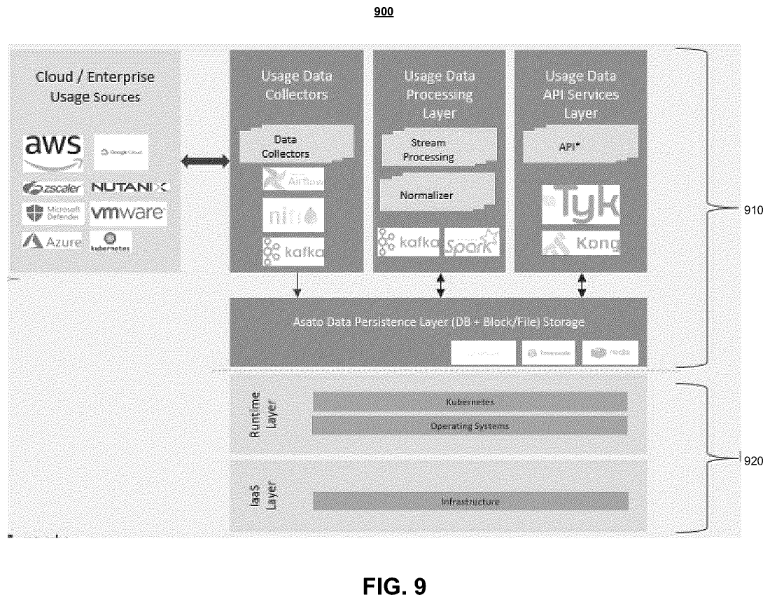

FIG. 9 illustrates an example of an asset usage storage processing logical view in an AI-powered enterprise copilot system, according to an embodiment. In this example, the information is retrieved from a cloud or enterprise usage source. As explained in FIG. 6, process 910 can include one or more of asset data information stages 600 in the AI-powered enterprise copilot system.

Further, the data received in process 910 can further undergo through process 920. Process 920 comprises a runtime layer and an IaaS layer. A runtime layer and an Infrastructure as a Service (IaaS) layer serve distinct but complementary roles in the AI-powered enterprise copilot system. The runtime layer provides the environment necessary for executing applications of the operating systems, managing tasks like memory allocation and system interactions. On the other hand, the IaaS layer offers foundational computing resources over the cloud, including storage, and networking.

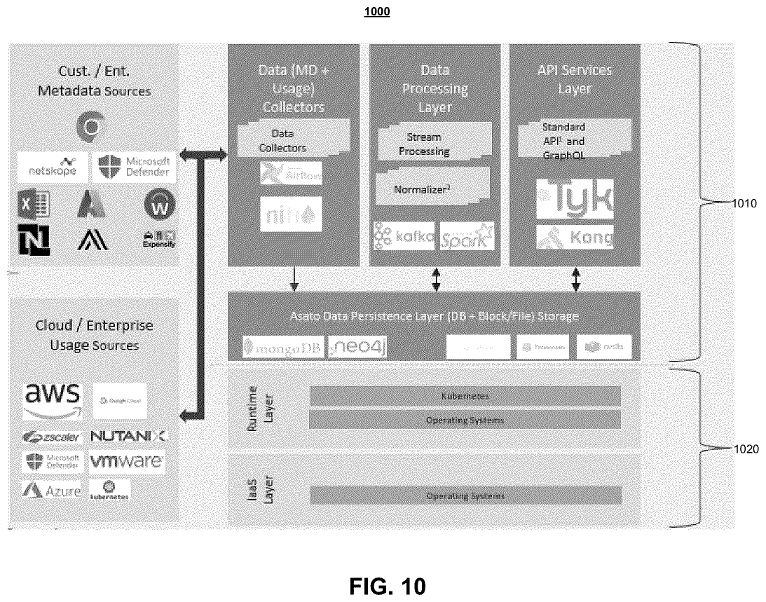

FIG. 10 illustrates an example of an asset plane processing logical view in an AI-powered enterprise copilot system, according to an embodiment. In this example, the information is retrieved from a combination of a customer or enterprise metadata source and a cloud or enterprise usage source. As explained in FIG. 6, process 1010 can include one or more of asset data information stages 600 in the AI-powered enterprise copilot system.

Further, the data received in process 1010 can further undergo through process 1020. Process 1020 comprises a runtime layer and an Infrastructure as a Service (IaaS) layer. A runtime layer and an IaaS layer serve distinct but complementary roles in the AI-powered enterprise copilot system. The runtime layer provides the environment necessary for executing applications of the operating systems, managing tasks like memory allocation and system interactions. On the other hand, the IaaS layer offers foundational computing resources over the cloud, including storage, and networking.

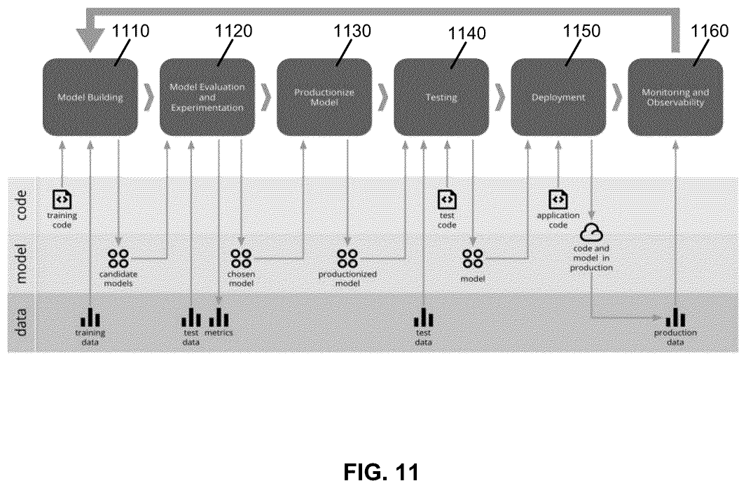

FIG. 11 illustrates an example of a knowledge plane data insight generation 1100 in an AI-powered enterprise copilot system, according to an embodiment. Knowledge plane data insight generation 1100 comprises a model building module 1110, a model evaluation and experimentation 1120, a productionize model module 1130, a testing phase 1140, deployment 1150, and a monitoring and observability phase 1160.

The function of model building module 1110 is to create a system that can learn patterns and make predictions or decisions based on a training code and training data. Model building module 1110 begins with collecting and preparing data, which is then used to train the model by adjusting its parameters to minimize errors in its recommendations of candidate models. The core function of model building module 1110 is to identify relationships and patterns within the data, enabling it to make accurate recommendations or classifications on new, undiscovered assets. Once trained, model building module 1110 can be evaluated for performance and refined as needed in model evaluation and experimentation 1120.

Under model evaluation and experimentation 1120, AI-powered enterprise copilot system assesses the performance and reliability of a candidate model. Evaluation involves testing the data and obtaining metrics depending on the task. Model evaluation and experimentation 1120 helps determine how effectively the candidate model generalizes from the training data to real-world applications such as asset association and relationship. Experimentation, on the other hand, involves testing different candidate model configurations to identify improvements and optimize performance. For example, in model evaluation and experimentation 1120, a user can evaluate the accuracy of the data information associated with users, asset classes and costs. Further, a user can evaluate whether a processor detects undiscovered existing users and assets. After model evaluation and experimentation 1120, a chosen model can proceed to productionize model module 1130.

In productionize model module 1130, a chosen model proceeds to perform real-world applications. Basically, the chosen model transitions from a development environment into a production setting where it can be used in the AI-powered enterprise copilot system. This involves several key tasks: integrating the model into existing systems or workflows, ensuring it can handle live data inputs efficiently, and providing robust interfaces for users or other systems to interact with it. For example, the chosen model can undergo a test to process the data information to identify valid users and asset classes, anomalies, and relationships between usage and costs in an enterprise.

After, a productionized model undergoes testing under testing phase 1140. The function of testing phase 1140 is to ensure that the productionized model operates accurately and reliably before it is deployed. This involves evaluating the productionized model's performance on a separate test dataset 312 and test code to measure its ability to generalize to new, unseen data, using metrics such as accuracy, precision, and recall. After testing phase 1140, a model is deployed under deployment 1150.

Deployment 1150 refers to the integration of a trained model into a live production environment where it can make predictions or decisions based on real-world data. Deployment can include setting up the necessary infrastructure for the model to operate, such as servers, application codes, APIs, or cloud services, to ensure it can scale and perform efficiently under actual usage conditions. The data produced is controlled through monitoring and observability phase 1160 to ensure that the training data entering model building module is reliable. In monitoring and observability phase 1160, feedback can be provided to train LLM module 420. The feedback can include user generated feedback, as shown in FIG. 5.

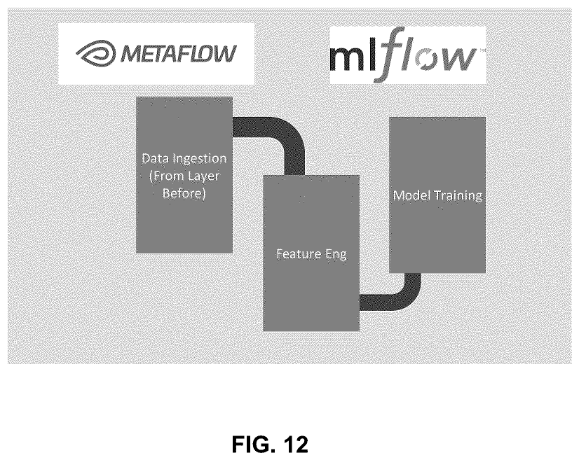

FIG. 12 illustrates an example of an insight model in an AI-powered enterprise copilot system, according to an embodiment. As described in FIG. 6, data ingestion can comprise collecting, importing, and processing data for use in the AI-powered enterprise copilot system. Data ingestion involves gathering raw data from various sources, such as enterprise databases or a cloud, and preparing it for analysis. Data ingestion can include tasks like cleaning, transforming, and organizing the data to ensure it is in a suitable format for the AI-powered enterprise copilot system.

Further, the AI-powered enterprise copilot system integrates an AI feature engineering for data analysis and pattern recognition. The feature engineering in an AI system involves creating, transforming, and selecting input features that enhance the AI-powered enterprise copilot system ability to learn from data and make accurate asset allocation recommendations and detection. This process includes identifying active assets of an enterprise features to perform a data analysis and pattern recognition that best represent the underlying patterns and relationships in the data to optimize asset allocation in an enterprise. It may involve techniques such as normalization, encoding categorical variables, creating new features from existing ones, and handling missing assets in an enterprise. Additionally, the AI-powered enterprise copilot system can include a machine learning feature with one or more LLM module 420 configured to perform an analysis of the usage information on the enterprise asset by the enterprise user to optimize asset allocation in an enterprise. LLM module 420, in processor 210, can further derive the usage information on the enterprise asset by the enterprise user by evaluating demographics, conducting cost analysis, addressing security and compliance issues, and providing detailed usage data history to determine the usage and location of the assets.

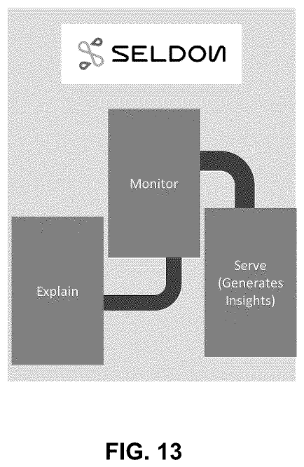

FIG. 13 illustrates an example of a generated insight model 1300 in an AI-powered enterprise copilot system, according to an embodiment. As summarized in FIG. 13, an LLM module 420 can explain, monitor, and generate insights through advanced language understanding and generation capabilities. LLM module 420 can explain complex concepts by interpreting and summarizing information from an enterprise or cloud datasets 312, providing clear and coherent descriptions that make intricate topics accessible. For monitoring, an LLM can analyze large volumes of text or data streams to identify patterns, anomalies, or emerging trends. When it comes to generating insights, LLM module 420 can synthesize the information to produce actionable recommendations that can be materialized if implemented into the AI-powered enterprise copilot system. Further, FIG. 11 provides a detailed description of a process applicable to generating insight model 1300.

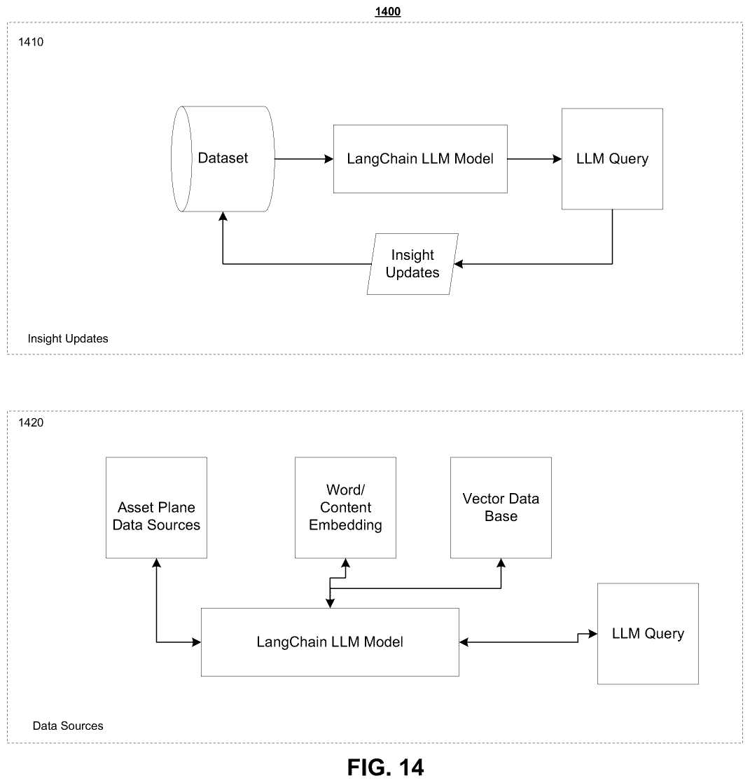

FIG. 14 illustrates an example of a large language model training 1400 using retrieval-augmented generation (RAG) in an AI-powered enterprise copilot system, according to an embodiment. As exemplified in process 1410, large language model training 1400 can comprise using a RAG for post-processing and augmentation purposes. RAG can enhance LLM module's 420 performance by combining generative capabilities with a retrieval mechanism. First, enhanced LLM module 420 retrieves relevant information from dataset 312.

Then, it uses dataset 312 retrieved information to generate a more accurate and contextually relevant response through text processing. For example, LLM module 420 can comprise a LangChain model. Through the LangChain model, LLM module 420 can chain together various components to create more sophisticated applications. This modular approach allows the AI-powered enterprise copilot system to integrate LLM module 420 with retrieval systems, APIs, and other external services, enabling the construction of complex, context-aware interactions. Further, as shown in process 1420, the LangChain model can automatically integrate and incorporate new information from data sources including asset plane 430, word and/or content embedding sources, a vector database, and/or LLM module 420 query.

By integrating external dataset 312 sources, RAG can improve LLM module's 420 ability to provide insight and recommendation for asset allocation and contribute to the continuous improvement of LLM module 420.

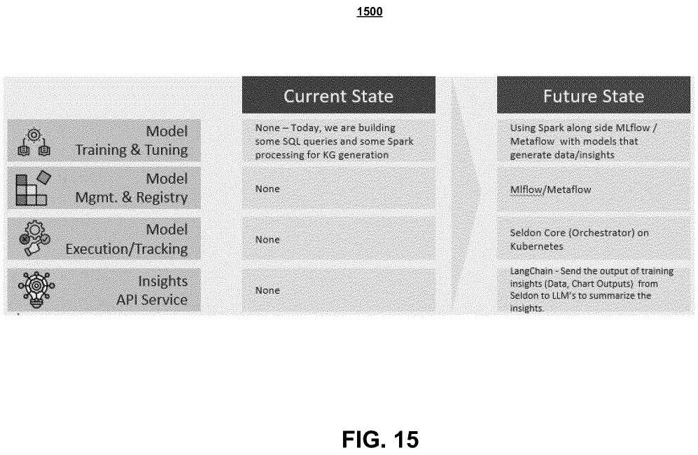

FIG. 15 illustrates a knowledge plane 440 and future state, according to an embodiment. As previously described in FIG. 4, Knowledge plane 440 refers to the conceptual layer that represents the model's internal understanding and organization of knowledge received from asset plane 430. This includes the vast array of information associated with the assets, users, costs, and usage that the model has been trained on, encompassing patterns, relationships, and domain-specific content. Here, the AI-powered enterprise copilot system can make inferences, and provide insights, reflecting LLM module 420 depth and breadth of learned information.

As shown in FIG. 15, the future applications of knowledge plane 440 can include model training and tuning using Spark alongside MLflow/Metaflow with models that generate data/insights. Further, knowledge plane 440 has capabilities to include a model management and registry system, a model execution and/or tracking system, and an insights API service.

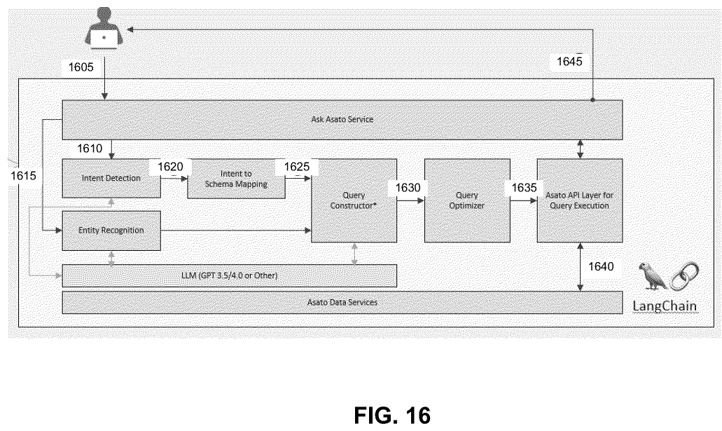

FIG. 16 illustrates an example of an AI-powered enterprise copilot system, according to an embodiment. The current figure illustrates the system's process in a practical, real-world context, effectively capturing its operational flow.

User interface 1605 with LLM module 420 application in the AI-powered enterprise copilot system operates by enabling users to interact with the model through text-based inputs and outputs. When a user types a query or command via user interface 1605, the AI-powered enterprise copilot system sends this input to LLM module 420, which processes the text to retrieve an intent detection 1610 and an entity recognition 1615. This retrieval process can be powered by LLM module 420, which includes operational systems such as GPT 3.5/4.0 and/or others. Further, this operation can be supported by an enterprise's data services. User interface 1605 can include a conversational agent interface configured to allow for a user to converse with an agent using LLM module 420 and a natural language processing (NLP).

After intent detection 1610 is decoded by LLM module 420, the AI-powered enterprise copilot system creates the intent into a schema mapping 1620 to retrieve and detect assets within an enterprise. Here, a relationship between usage, costs, users, and asset inventory can be mapped and further processes under query construction 1625.

Query construction 1625 can involve translating a user's request or requirement into a formal query language, such as SQL, that the database in the AI-powered enterprise copilot system can understand. Once constructed, query optimizer 1630 can evaluate various execution plans to determine the most efficient way to retrieve the requested data. Query optimizer 1635 can involve analyzing factors retrieved by intent into a schema mapping 1620 like usage, costs, users, and asset inventory. Query optimizer 1630 can select an asset drift and allocation recommendation for query execution 1635. Query execution 1635 can be configured to dynamically create charts and graphs based on user requests through query construction 1630.

Query execution 1635 can be materialized based on input data sensed by a processor on whether the recommendation made by query execution 1635 is accepted by a user, as shown recommendation 1645. Further, query execution 1635 can be used to provide insight into a service provider 1640.

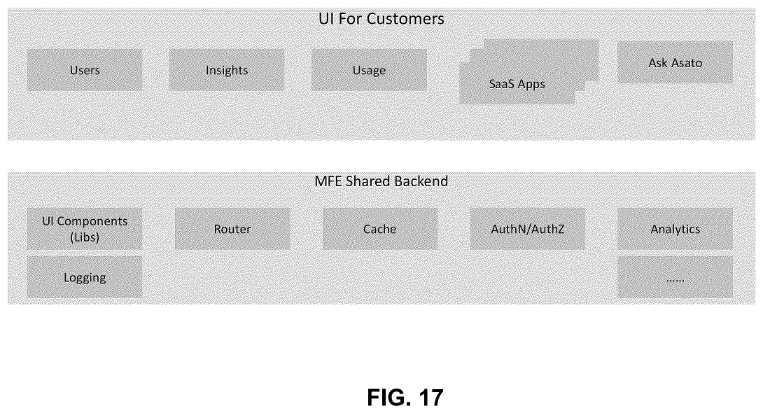

FIG. 17 illustrates an example of an MFE-based user interference design architecture in an AI-powered enterprise copilot system, according to an embodiment. In an MFE (Micro Frontend) based user interface for customers, the AI-powered enterprise copilot system can be designed to provide a modular experience across various SaaS applications. Users interact with a cohesive interface where they can access and manage enterprise asset data, gain insights, and monitor asset usage efficiently. The MFE architecture supports this experience through a backend that integrates several key components: reusable user interface libraries (libs) for consistent design elements, a router for navigation between different app modules, and a cache for fast data retrieval. Additionally, MFE-based user interface can include authentication and authorization mechanisms (AuthN/AuthZ) to ensure secure access, analytics and performance tools, and logging capabilities.

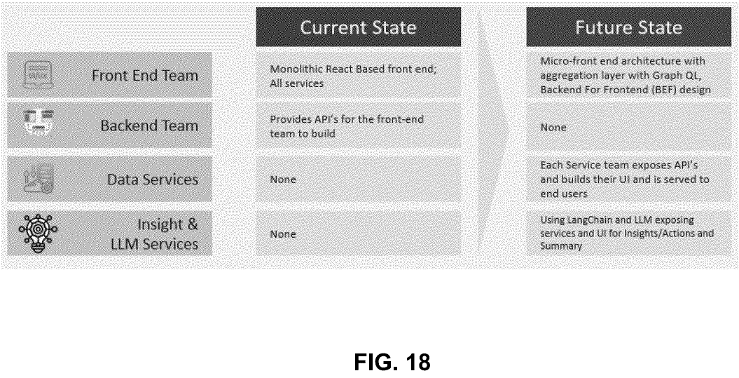

FIG. 18 illustrates a user interference and/or user plane in an AI-powered enterprise copilot system, according to an embodiment. As shown, Front end team current state has capabilities for micro-front end architecture with aggregation layer with Graph QL and a backend For Frontend (BEF) design. Further, the data services has potential applications where each Service team exposes API's and builds their UI and is served to end users. Finally, the insight and LLM services can be applied using LangChain and LLM exposing services and UI for insights and/or actions and summary.

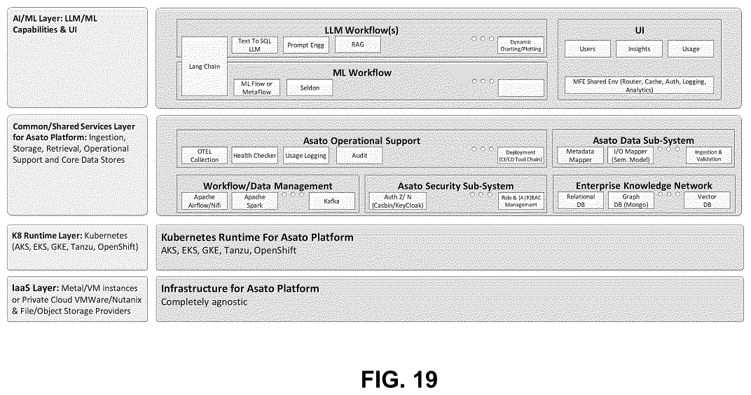

FIG. 19 a high-level architecture of the AI utilized in an AI-powered enterprise copilot system, according to an embodiment. This figure represents a high-level architecture of the AI utilized in the AI-powered enterprise copilot system, offering an overview of its key components and their interactions. FIG. 19 integrates various aspects of the AI framework and LLM module 420, including data processing, model management, and deployment. The details depicted in this figure are derived from a combination of one or more previously described figures, which together provide a comprehensive understanding of how the AI-powered enterprise copilot system operates. By synthesizing these elements, the figure illustrates the overall design and functionality of the AI and LLM module 420, highlighting how different components collaborate to achieve the AI-powered enterprise copilot system's objectives.

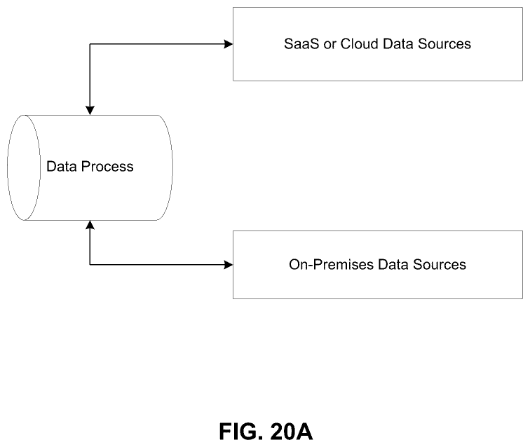

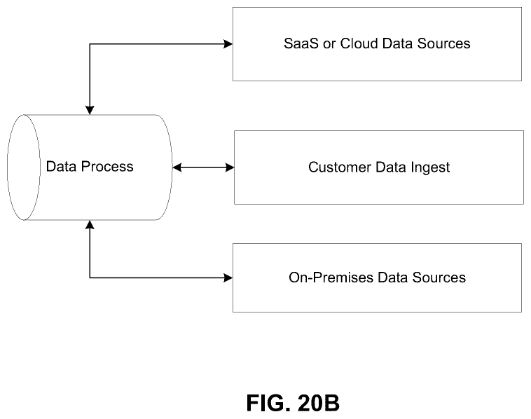

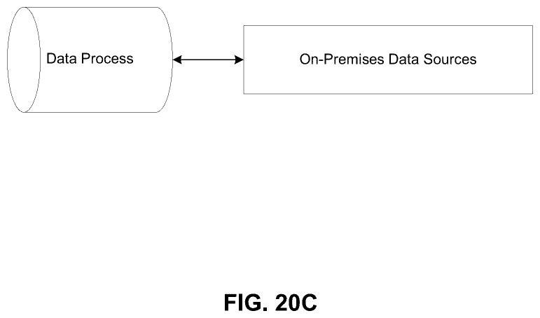

FIGS. 20A-C illustrate dataset 312 variations in an AI-powered enterprise copilot system, according to an embodiment. In FIG. 20A, dataset 312 originates from a cloud-type systems. Datasets 312 can reside in cloud storage solutions, such as Amazon S3, Google Cloud Storage, or Microsoft Azure Blob Storage, where they are stored securely and can be accessed from anywhere. Dataset 312 may be generated and collected from various cloud-based applications and services, including web analytics platforms, IoT devices, and user interactions, which continuously upload data to the cloud. Additionally, cloud databases and data warehouses, like Google BigQuery or Amazon Redshift, provide structured and semi-structured datasets that can be queried and analyzed efficiently.

On the other hand, FIG. 20C shows a dataset from customer and/or enterprise metadata sources derived from various internal records and information systems that catalog and manage the enterprise's operational, organizational, and transactional data. These metadata sources can include databases, data warehouses, and enterprise resource planning (ERP) systems. Finally, FIG. 20 provides a hybrid alternative that combines customer and/or enterprise metadata sources and cloud-type systems.

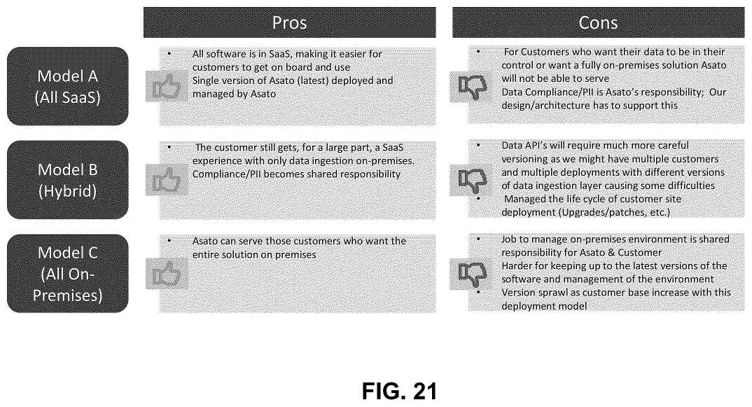

FIG. 21 illustrates the pros and cons of an AI-powered enterprise copilot system based on different dataset variations. As shown, an all-SaaS model can make it easier for customers to get on board and use. Further, a single version can be deployed by the service provider. However, it may be challenging for customers who want their data to be in their control or want a fully on-premises solution the service provider will not be able to provide.

For hybrid models, the customer still gets, for a large part, SaaS experience with only data ingestion on-premises. Also, compliance and PII becomes shared responsibility. On the other hand, data API's will require much more careful versioning as we might have multiple customers and multiple deployments with different versions of the data ingestion layer causing some difficulties. Additionally, a management of the life cycle of customer site deployment (Upgrades/patches, etc.) can be required.

Finally, an all on-premises model can serve those customers who want the entire solution on premises. However, the job of managing on-premises environment is shared responsibility for the service provider and the customer. This can be harder for keeping up to the latest versions of the software and management of the environment. Further, version sprawl as customer base increase with this deployment model.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

### INDUSTRIAL APPLICABILITY

In today's complex IT landscape, CIOs face significant challenges, including managing siloed systems, optimizing resource allocation, and delivering tangible results. The top 3 investment line items for an enterprise CIO are headcount, software, and hosting, but most enterprises aren't getting the appropriate return on their investment. All of this points to a robust and growing market for just the Kost skill sub-segment: $4B+ today growing to $10B+ in the next 5 years.

Generative AI represents a seismic shift for the enterprise and enterprise software, enabling new possibilities for automation, personalization, and innovation. It could transform business landscapes by enabling companies to automate content generation, make predictions, customize user experiences, and enhance decision-making capabilities. Generative-relevant use cases already present a significant enterprise opportunity, estimated to reach $42.6 billion in 2023 according to Pitchbook, with natural language interfaces offering the largest market due to customer service and sales automation use cases. Pitchbook expects the market at a 32.0% CAGR to reach $98.1 billion by 2026, even without accounting for the potential of generative AI to expand the total addressable market of AI software to consumers and new user personas in the enterprise.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of engine. Hence, although the present embodiments are, for convenience of explanation, depicted and described as being implemented in a LLM model, it will be appreciated that it can be implemented in various other types of engines that may perform an analysis of the usage of enterprise assets by the users and generate a recommendation to drift asset allocation in an enterprise, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A non-transitory computer-readable medium having instructions stored to generate decision recommendations to optimize asset allocation in an enterprise, wherein the instructions, when executed by a processor, cause the processor to:
obtain data information of an enterprise from more than one source,
wherein the data information is associated with users, asset classes and costs,
wherein the processor detects undiscovered existing users and assets;
process the data information to identify valid users and asset classes, anomalies, and relationships between usage and costs;
generate a mapping of the valid users and valid asset classes to define a relationship and associated trend between an enterprise asset, an enterprise user, and enterprise costs;
derive a usage information on the enterprise asset by the enterprise user based on the relationship and associated trend between the enterprise asset, enterprise user, and enterprise costs;
provide the usage information on the enterprise asset by the enterprise user to an artificial intelligence (AI) system for data analysis and pattern recognition,
wherein the AI system includes one or more large language model module configured to perform an analysis of the usage information on the enterprise asset by the enterprise user to optimize asset allocation in an enterprise,
wherein the large language model module utilizes a natural language processing interface;
analyze the recommendation based on whether the recommendations have materialized in the enterprise,
wherein the enterprise performs an action based on whether the recommendation has materialized; and
use a result of the optimizing of the asset allocation to train the large language model module.

2. The processor of claim 1, wherein the data information comprises information from a cloud.

3. The processor of claim 1, wherein the data information comprises information from an enterprise premises data source.

4. The processor of claim 1, wherein the data information comprises information from a cloud and enterprise premises data sources.

5. The processor of claim 1, wherein the processor further derives the usage information on the enterprise asset by the enterprise user by evaluating demographics, conducting cost analysis, addressing security and compliance issues, and providing detailed usage data history to determine the usage and location of the assets.

6. The processor of claim 1, wherein users can provide feedback to train the large language model module.

7. The processor of claim 1, wherein the processor can automatically incorporate new data information.

8. The processor of claim 1, further comprising conversational agent interface configured to allow for a user to converse with an agent using the large language model module and a natural language processing (NLP).

9. The processor of claim 8, wherein the NLP is configured to dynamically create charts and graphs based on user requests.

10. The processor of claim 1, wherein the large language model module comprises a drift asset allocation to optimize of the asset allocation in an enterprise.

11. The processor of claim 1, wherein the recommendation is materialized based on input data sensed by the processor on whether the recommendation is accepted by a user.

12. A method comprising using at least one hardware processor to:
obtaining data information of an enterprise from more than one source;
wherein the data information is associated with users, asset classes and costs,
wherein the processor detects undiscovered existing users and assets;
processing the data information to identify valid users and asset classes, anomalies, and relationships between usage and costs;
generating a mapping of the valid users and valid asset classes to define a relationship and associated trend between an enterprise asset, an enterprise user, and enterprise costs;
deriving a usage information on the enterprise asset by the enterprise user based on the relationship and associated trend between the enterprise asset, enterprise user, and enterprise costs;
providing the usage information on the enterprise asset by the enterprise user to an artificial intelligence (AI) system for data analysis and pattern recognition,
wherein the AI system includes one or more large language model module configured to perform an analysis of the usage information on the enterprise asset by the enterprise user to optimize asset allocation in an enterprise,
wherein the large language model module utilizes a natural language processing interface;
analyzing the recommendation based on whether the recommendations have materialized in the enterprise,
wherein the enterprise performs an action based on whether the recommendation has materialized; and
using a result of the optimizing of the asset allocation to train the large language model module.

13. The processor of claim 12, wherein the processor computes the enterprise asset and user relationship by evaluating demographics, conducting cost analysis, addressing security and compliance issues, and providing detailed usage data history to determine the usage and location of the assets.

14. The processor of claim 12, wherein users can provide feedback to train the large language model module.

15. The processor of claim 12, further comprising a conversational agent interface configured to allow for a user to converse with an agent using the large language model module and a natural language processing (NLP).

16. A system to generate decision recommendations to optimize asset allocation in an enterprise, the system comprising:
at least one hardware processor; and
software that is configured to, when executed by the at least one hardware processor,
obtaining data information of an enterprise from more than one source,
wherein the data information is associated with users, asset classes and costs,
wherein the processor detects undiscovered existing users and assets;
processing the data information to identify valid users and asset classes, anomalies, and relationships between usage and costs,
generating a mapping of the valid users and valid asset classes to define a relationship and associated trend between an enterprise asset, an enterprise user, and enterprise costs;
deriving a usage information on the enterprise asset by the enterprise user based on the relationship and associated trend between the enterprise asset, enterprise user, and enterprise costs,
providing the usage information on the enterprise asset by the enterprise user to an artificial intelligence (AI) system for data analysis and pattern recognition,
wherein the AI system includes one or more large language model module configured to perform an analysis of the usage information on the enterprise asset by the enterprise user to optimize asset allocation in an enterprise,
wherein the large language model module utilizes a natural language processing interface;
analyzing the recommendation based on whether the recommendations have materialized in the enterprise,
wherein the enterprise performs an action based on whether the recommendation has materialized, and
using a result of the optimizing of the asset allocation to train the large language model module.

17. The system of claim 16, wherein the processor computes the enterprise asset and user relationship by evaluating demographics, conducting cost analysis, addressing security and compliance issues, and providing detailed usage data history to determine the usage and location of the assets.

18. The system of claim 16, wherein users can provide feedback to train the large language model module.

19. The system of claim 16, further comprising a conversational agent interface configured to allow for a user to converse with an agent using the large language model module and a natural language processing (NLP).

20. The system of claim 19, wherein the NLP is configured to dynamically create charts and graphs based on user requests.
